(19) United States
(12) Patent Application Publication
(10) Pub. No.: US 2011/0120870 A1
(43) Pub. Date: May 26, 2011

(54) METHOD AND APPARATUS FOR TREATING A FLUID

(76) Inventors: Eric John Kruger, Erie, PA (US); William F Freije, III, Indianapolis, IN (US)

(21) Appl. No.: 12/672,816

(22) PCT Filed: Aug. 11, 2008
(86) PCT No.: PCT/US08/09620

§ 371 Date: May 21, 2010

Related U.S. Application Data
(60) Provisional application No. 60/955,244, filed on Aug. 10, 2007.
(60) Provisional application No. 61/087,870, filed on Aug. 11, 2008.

(51) Int. Cl. B01D 61/42; B01D 61/56

(52) U.S. Cl. 204/518; 204/627

(57) ABSTRACT

A fluid treatment system is disclosed wherein a fluid is passed through a membrane and is treated with an electrical treatment device. The electrical treatment device may include a wire wrapped about a fluid conduit and a control unit. The electrical treatment device may include a first electrode, a second electrode, and a control unit. The first electrode and the second electrode may be in contact with the fluid.

### CROSS REFERENCE TO RELATED APPLICATIONS

This application is a national stage application of PCT Application No. PCT/US2008/009620 which claims the benefit of U.S. Provisional Patent Application Ser. No. 60/955,244 and which claims the benefit of U.S. Provisional Patent Application Ser. No. 61/087,870, the disclosures of which are expressly incorporated by reference herein.

This application is related to U.S. patent application Ser. No. 11/837,225, filed Aug. 10, 2007, titled “FLUID TREATMENT DEVICE”, Atty. Docket FRE-P0001 and U.S. Provisional Patent Application Ser. No. 60/955,253, filed Aug. 10, 2007, titled “METHOD AND APPARATUS FOR TREATING A FLUID”, Atty. Docket FRE-P0005, the disclosures of which are expressly incorporated by reference herein.

### BACKGROUND AND SUMMARY OF THE INVENTION

The present invention relates to fluid treatment devices and in particular to fluid treatment devices including a membrane and an electrical fluid treatment unit.

It is known to pass fluid to be treated through a membrane such that the fluid is separated into a permeate stream and a waste stream. The membrane over time may become plugged do to the dissolved solids like sodium and impurities like lead and arsenic present in the fluid to be treated becoming lodged in the membrane. Attempts to reduce the plugging of membranes include the addition of chemicals to the fluid to be treated.

It is known to reduce scale in a water based fluid by wrapping a pipe transporting the water based fluid with a wire having an alternating current passing there through. Exemplary systems include the EASYWATER brand water treatment system available from Freije Treatment Systems located at 4202 N. Awning Court, Greenfield, Ind. 46140 and the SERIES E brand treatment system also available from Freije Treatment Systems. Further, it is known to place electrodes in direct contact with a water based fluid as disclosed in U.S. patent application Ser. No. 10/493,094, assigned to Drexel University, the disclosure of which is expressly incorporated by reference herein.

In an exemplary embodiment of the present disclosure, a fluid treatment device for treating a water based fluid is provided. The fluid treatment device comprising a housing having at least one fluid inlet and at least two fluid outlets; a membrane positioned within the housing, a first electrode positioned within the housing; a second electrode positioned within the housing; and a control unit coupled to the first electrode and the second electrode, the control unit providing a potential difference between the first electrode and the second electrode. The membrane receiving the water based fluid from the at least one fluid inlet. The membrane separating the water based fluid into a permeate portion and a fluid waste portion. The permeate portion being communicated to at least a first fluid outlet of the at least two fluid outlets. The fluid waste portion being communicated to at least a second fluid outlet of the at least two fluid outlets. In one example, the first electrode and the second electrode are each in direct contact with the water based fluid. In another example, the first electrode and the second electrode are each coupled to the housing. In a further example, at least one of the first electrode and the second electrode includes openings which permit the water based fluid to pass therethrough. In a further example, at least one of the first electrode and the second electrode are a part of a fluid conduit for the permeate portion of the water based fluid. In still another example, at least one of the first electrode and the second electrode are a part of a fluid conduit for the fluid waste portion of the water based fluid. In yet another example, the fluid treatment device further comprises a fluid waste fluid conduit; and a permeate fluid conduit positioned within the fluid waste fluid conduit. The membrane is positioned within the fluid waste fluid conduit and outside of the permeate fluid conduit. The permeate fluid conduit includes openings to permit permeate within the fluid waste fluid conduit to enter the permeate fluid conduit. The first electrode is a part of the permeate fluid conduit. The second electrode is a part of the fluid waste fluid conduit.

In another exemplary embodiment of the present disclosure, a method for treating a fluid is provided. The method comprising the steps of providing a feed stream of a fluid to a membrane, the feed stream being pressure driven; collecting a first portion of the feed stream which passes through the membrane as a permeate stream; and treating the fluid by placing a first electrode and a second electrode in contact with the fluid and applying an alternating potential difference to the first electrode and the second electrode. In an example, the method further comprising the step of passing the fluid of the feed stream through a sediment filter prior to the fluid being provided to the membrane. In another example, the method further comprising the step of passing the fluid of the feed stream through a carbon filter prior to the fluid being provided to the membrane. In a further example, the method further comprising the step of passing the permeate stream through a carbon filter.

In a further exemplary embodiment of the present disclosure, a fluid treatment system for treating a water based fluid is provided. The fluid treatment system comprising a membrane unit including at least one fluid inlet, at least two fluid outlets, and a membrane. The membrane receives the water based fluid from the at least one fluid inlet and separates the water based fluid into a permeate portion and a fluid waste portion. The fluid treatment system further comprising a first fluid conduit in fluid communication with the at least one fluid inlet of the membrane unit, the first fluid conduit providing the water based fluid to the membrane unit; a second fluid conduit in fluid communication with a first fluid outlet, the second fluid conduit receiving the permeate portion; a third fluid conduit in fluid communication with a second fluid outlet, the third fluid conduit receiving the fluid waste portion; and a fourth fluid conduit in fluid communication with the first fluid conduit at a first location and with the third fluid conduit. The fourth fluid conduit providing at least a portion of the fluid waste portion to the first fluid conduit at the first location. The fluid treatment system further comprising an electrical treatment device including at least one wire and a control unit coupled to the at least one wire. The electrical treatment device providing an alternating potential over the at least one wire. The at least one wire being wrapped around a portion of the first fluid conduit to treat the water based fluid prior to entering the membrane unit. The portion of the first fluid conduit being between the first location and the membrane unit. In one example, the fluid treatment system further comprises a sediment filter which provides the water based fluid to the first fluid conduit. In another example, the fluid treatment system further comprises a carbon filter which provides the water based fluid to the first fluid conduit. In a further example, the fluid treatment system further comprises a carbon filter which receives the permeate portion from the second fluid conduit.

In yet another exemplary embodiment of the present disclosure, a fluid treatment system for treating a water based fluid is provided. The fluid treatment system comprising a membrane unit including at least one fluid inlet, at least two fluid outlets, and a membrane, the membrane receives the water based fluid from the at least one fluid inlet and separates the water based fluid into a permeate portion and a fluid waste portion. The fluid treatment system further comprising a first fluid conduit in fluid communication with the at least one fluid inlet of the membrane unit, the first fluid conduit providing the water based fluid to the membrane unit; a second fluid conduit in fluid communication with a first fluid outlet, the second fluid conduit receiving the permeate portion; a third fluid conduit in fluid communication with a second fluid outlet, the third fluid conduit receiving the fluid waste portion; and a fourth fluid conduit in fluid communication with the first fluid conduit at a first location and with the third fluid conduit. The fourth fluid conduit providing at least a portion of the fluid waste portion to the first fluid conduit at the first location. The fluid treatment device further comprising an electrical treatment device including at least two wires and at least one control unit coupled to the at least two wires. The at least one control unit providing an alternating potential over a first wire of the at least two wires and over a second wire of the at least two wires. The first wire being wrapped around a portion of the first fluid conduit to treat the water based fluid prior to entering the membrane unit. The portion of the first fluid conduit being prior to the first location. The second wire being wrapped around a portion of fourth fluid conduit. In one example, the fluid treatment system further comprises a sediment filter which provides the water based fluid to the first fluid conduit. In another example, the fluid treatment system further comprises a carbon filter which provides the water based fluid to the first fluid conduit. In a further example, the fluid treatment system further comprises a carbon filter which receives the permeate portion from the second fluid conduit.

In still another exemplary embodiment of the present disclosure, a fluid treatment device for treating a water based fluid is provided. The fluid treatment device comprising: at least two electrodes placed in direct contact with the water based fluid; a control unit coupled to the at least two electrodes to provide an alternating potential difference between the first electrode and the second electrode; and a reverse osmosis membrane positioned between the at least two electrodes. In one example, an outer conduit is the first electrode, an inner conduit is the second electrode, and the reverse osmosis membrane is positioned between the outer conduit and the inner conduit.

In yet still another exemplary embodiment of the present disclosure, a method for treating a fluid is provided. The method comprising the steps of providing a feed stream of fluid to a reverse osmosis membrane, the feed stream being pressure driven; collecting a first portion of the feed stream which passes through the membrane as a permeate stream; and treating the fluid by placing a first electrode and a second electrode in contact with the fluid and applying an alternating potential difference to the first electrode and the second electrode. In one example, at least one of the first electrode and the second electrode contacts the feed stream inside of the reverse osmosis membrane. In another example, at least one of the first electrode and the second electrode contacts the feed stream outside of the reverse osmosis membrane.

Additional features and advantages will become apparent to those skilled in the art upon consideration of the following detailed description of illustrative embodiments exemplifying the best mode of carrying out the invention as presently perceived.

### BRIEF DESCRIPTION OF THE DRAWINGS

The detailed description of the drawings particularly refers to the accompanying figures in which:

FIG. 1 illustrates a representative view of a fluid treatment system including a membrane unit;

FIG. 2 illustrates a representative view of the membrane unit of FIG. 1;

FIG. 3 illustrates a perspective view of an exemplary membrane unit;

FIG. 4 illustrates another perspective view of the membrane unit of FIG. 3;

FIG. 5 illustrates an exploded view of the membrane unit of FIG. 3;

FIG. 6 illustrates an end view of a housing portion of the membrane unit of FIG. 3 looking at an interior of the housing portion;

FIG. 7 illustrates an end view of a housing portion of the membrane unit of FIG. 3 looking at an exterior of the housing portion;

FIG. 8 illustrates a sectional view of the membrane unit of FIG. 3 along lines 8-8 in FIG. 3 along with two potential placement locations for the second electrode;

FIG. 8A illustrates the separation of a fluid by a membrane;

FIG. 9 illustrates a representative view of another exemplary membrane unit;

FIG. 10 illustrates a cross-section of FIG. 9 along lines 10-1;

FIG. 11 illustrates a representative view of a wrap-around fluid treatment system;

FIG. 12 illustrates a representative view of another wrap-around fluid treatment system.

FIG. 13 illustrates a representative view of the membrane unit of FIG. 8 connected to a fluid source or feed conduit, a permeate conduit, and a waste conduit and the control unit;

FIG. 14 illustrates a representative view of another membrane unit; and

FIG. 15 illustrates an exemplary cooling system incorporating one or more treatment devices.

Corresponding reference characters indicate corresponding parts throughout the several views. Unless stated otherwise the drawings are proportional.

### DETAILED DESCRIPTION OF THE DRAWINGS

The embodiments disclosed below are not intended to be exhaustive or to limit the invention to the precise forms disclosed in the following detailed description. Rather, the embodiments are chosen and described so that others skilled in the art may utilize their teachings. For example, while the following description refers primarily to a fluid treatment system for water, it should be understood that the principles apply equally to fluid treatment systems for other types of fluid.

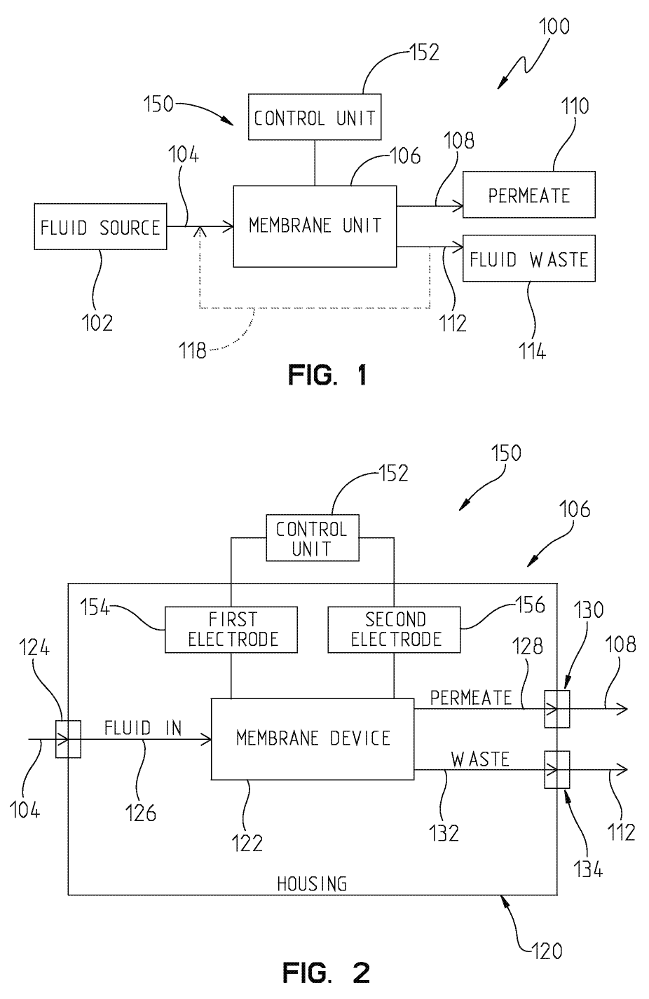

Referring to FIG. 1, an exemplary fluid treatment device 100 is shown. Fluid treatment device 100 receives a fluid to be treated from a fluid source 102 through a conduit 104. Exemplary conduits include any devices for supporting or transporting a fluid. Exemplary fluid sources 102 include a well, a municipal water supply, or other providers of fluid.

The fluid passes from conduit 104 into a membrane unit 106. While passing through membrane unit 106, the fluid is separated into a permeate stream or portion 110 and a fluid waste stream or portion 114. In one embodiment, the fluid is separated into generally pure water and water carrying the contaminants which were present in the fluid from the fluid source. Exemplary contaminants include salts, oils, chemicals, and other types of contaminants.

The permeate stream 110 is passed out of membrane unit 106 through a fluid conduit 108 and on to an application device. Exemplary application devices include once through application devices, such as a faucet, a coffee maker, an ice maker, a water heater, or other suitable device which provides or otherwise utilizes a fluid. In one embodiment, the permeate stream is provided to a storage tank for future use. In one embodiment, membrane unit provides domestic water to a whole facility (such as a house or other structure). The membrane unit both purifies the water and softens the water. In one embodiment, membrane unit treats municipal waste water. In one example, the membrane unit treats the municipal waste water to remove sodium, chlorine, and other contaminants from the waste water. In one embodiment, the membrane unit treats sea water for use in municipal water systems. In one example, the membrane unit treats the sea water to remove salts from the water.

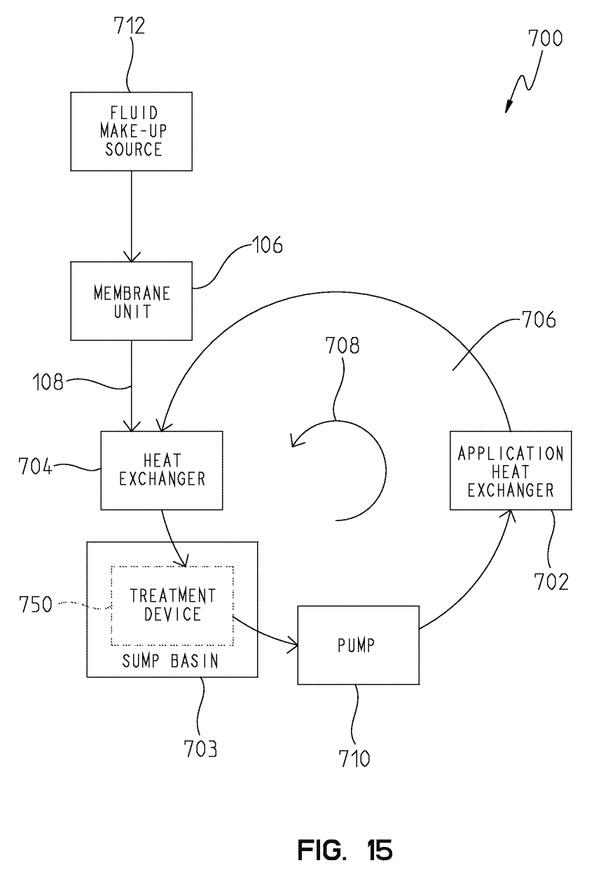

In one embodiment, the membrane unit is used to treat water provided as a make-up source 712 for a heat exchanger 704. Referring to FIG. 15, a heat exchanger system 700 includes an application heat exchanger 702, a heat exchanger 704, and piping 706 connecting heat exchanger 704 and application heat exchanger 702. Fluid 106 flows through application heat exchanger 702, heat exchanger 704, and piping 706 in a circuit 708. Heat exchanger 704 cools fluid 106 to a lower temperature. Exemplary heat exchangers 704 include cooling towers. The cooled fluid 106 is collected in a sump basin 703 and is pumped by a pump 710 back to application heat exchanger 702 whereat it takes on heat. While in the sump basin, the fluid may be treated by a treatment unit 750 disclosed in U.S. Provisional Patent Application Ser. No. 60/955,253, filed Aug. 10, 2007, titled METHOD AND APPARATUS FOR TREATING A FLUID, Atty. Docket FRE-P0005, the disclosure of which is expressly incorporated by reference herein. Application heat exchanger 702 corresponds to the application use of the cooled fluid 106 provided by heat exchanger 704. Exemplary application heat exchangers 702 include chillers, fan coil units, manufacturing machinery, electrical power generation equipment, and other suitable devices. In one embodiment, application heat exchanger 702 is a heat exchanger for a pressurized closed loop circuit that has an application heat exchanger of its own. Exemplary closed loop circuits are provided in U.S. Provisional Patent Application Ser. No. 60/834,826, filed Aug. 1, 2006 and U.S. Utility patent application Ser. No. 11/830,148, filed Jul. 30, 2007, the disclosures of which are expressly incorporated by reference herein.

In the illustrated embodiment, circuit 708 is an open loop and a makeup fluid source 712 is provided to replace any fluid 106 that may be lost. An exemplary heat exchanger 704 for an open loop circuit 708 is an evaporative cooling tower. With an evaporative cooling tower, fluid 106 may be lost due to evaporation, drift, and the removal of fluid during a blow down operation. As shown in FIG. 15, membrane unit 106 is provided to treat the fluid from make-up source 712 being provided to heat exchanger 704. In one example, the fluid from the make-up source is provided to sump basin 703.

In one embodiment, membrane unit 106 treats industrial waste water to remove contaminants from the water.

Returning to FIG. 1, the fluid waste stream 114 is passed out of membrane unit 106 through a fluid conduit 112. In one embodiment, the fluid waste stream 114 is passed to a drain or other disposal system. In one embodiment, a portion of fluid waste stream 114 may pass from fluid conduit 112 to conduit 104 through a fluid conduit 118. This recycled portion of fluid waste stream 114 will again pass through membrane unit 106 in hope of recovering more permeate stream 110 therefrom.

Referring to FIG. 2, a representation of membrane unit 106 is shown. Membrane unit 106 includes a housing 120 which houses a membrane device 122. Housing 120 includes a fluid inlet 124 through which fluid in conduit 104 passes to a fluid conduit 126 of membrane unit 106. Fluid conduit 126 provides the fluid to membrane device 122. As the fluid passes through membrane device 122, the fluid is separated into permeate and fluid waste. The permeate is communicated through a fluid conduit 128 to a first fluid outlet 130. Fluid conduit 108 is coupled to first fluid outlet 130 so that fluid passes from first fluid outlet 130 onto fluid conduit 108. The fluid waste is communicated through a fluid conduit 132 to a second fluid outlet 134. Fluid conduit 112 is coupled to second fluid outlet 134 so that fluid passes from fluid conduit 132 onto fluid conduit 112.

An electrical treatment device 150 is associated with membrane unit 106. Electrical treatment device 150 includes a control unit 152 which is operatively coupled to a first electrode 154 and a second electrode 156. First electrode 154 and second electrode 156 are in contact with at least a portion of the fluid as it passes through membrane unit 106. In one embodiment, first electrode 154 and second electrode 156 may be comprised of multiple components which cooperate to act as first electrode 154 and second electrode 156, respectively. In one embodiment, each of first electrode 154 and second electrode 156 are single components. In one embodiment, first electrode 154 and second electrode 156 contact surrounding fluid, but do not allow the fluid to pass through the respective first electrode 154 and second electrode 156. In one embodiment, first electrode 154 and second electrode 156 include openings to permit the fluid to pass through the respective first electrode 154 and second electrode 156. In one embodiment, first electrode 154 and second electrode 156 are a part of housing 120 of membrane unit 106, are affixed to housing 120 of membrane unit 106, are a part of fluid conduit 126, are affixed to fluid conduit 126, are a part of membrane device 122, or are affixed to membrane device 122.

First electrode 154 and second electrode 156 are coupled to control unit 152. Control unit 152 provides a potential difference between first electrode 154 and second electrode 156. By applying a potential difference between first electrode 154 and second electrode 156, buildup in the membrane 12, such as scale, may be reduced. This leads to a longer membrane life and/or to a higher recovery rate of permeate 110. Further, the use of membrane unit 106 may replace the use of chemicals which are traditionally used to promote increased membrane life.

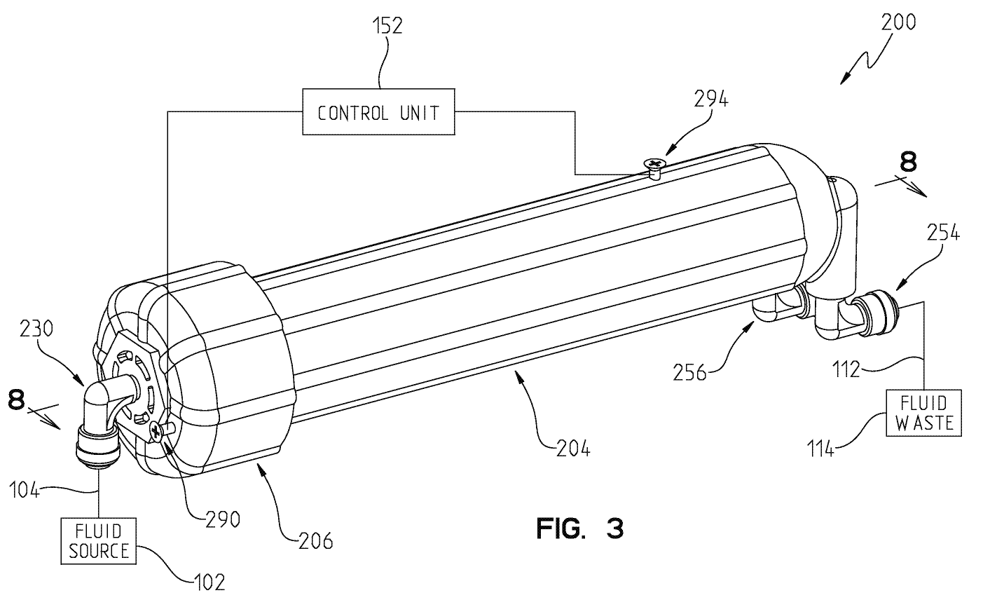

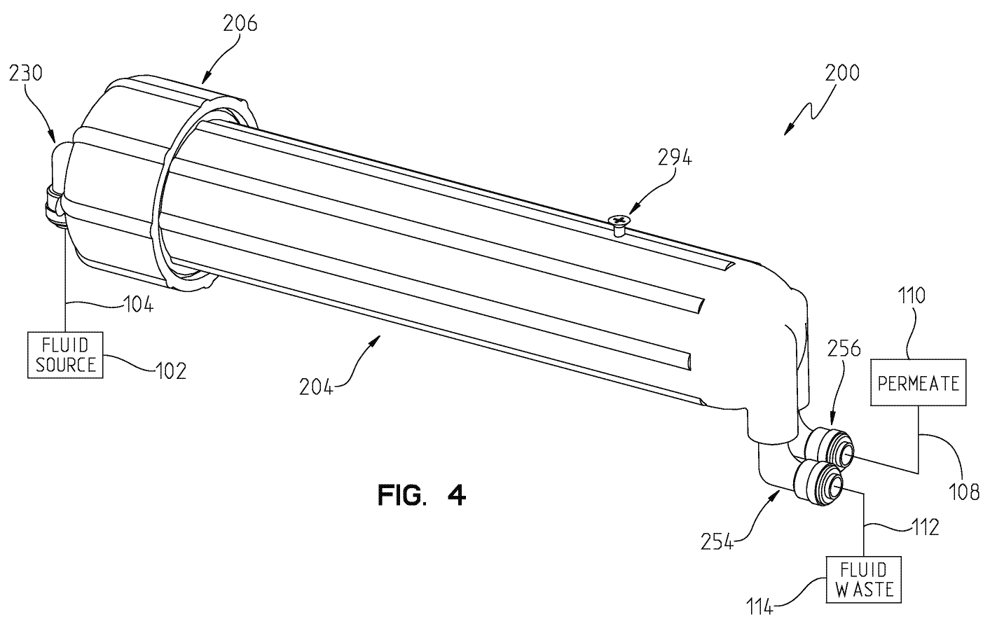

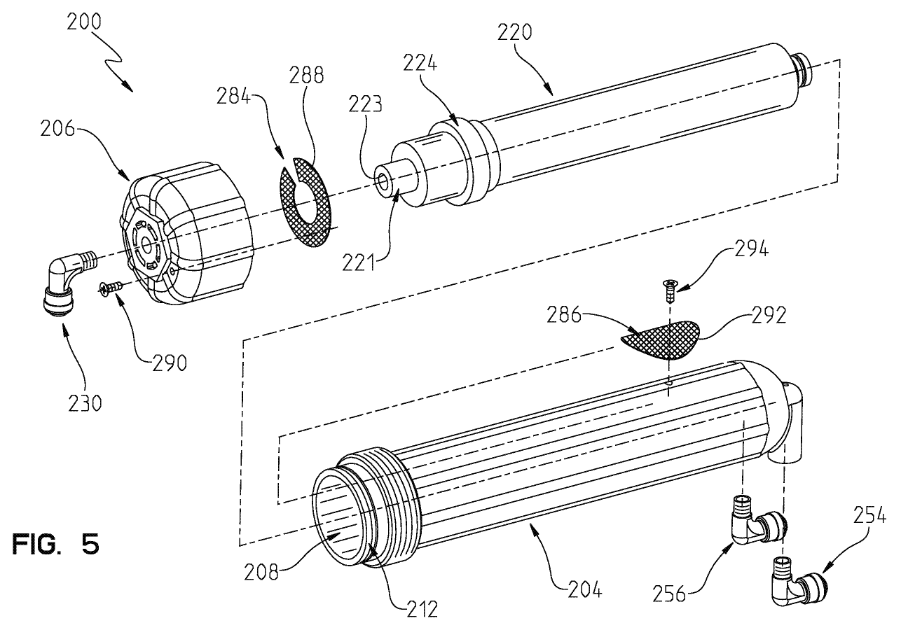

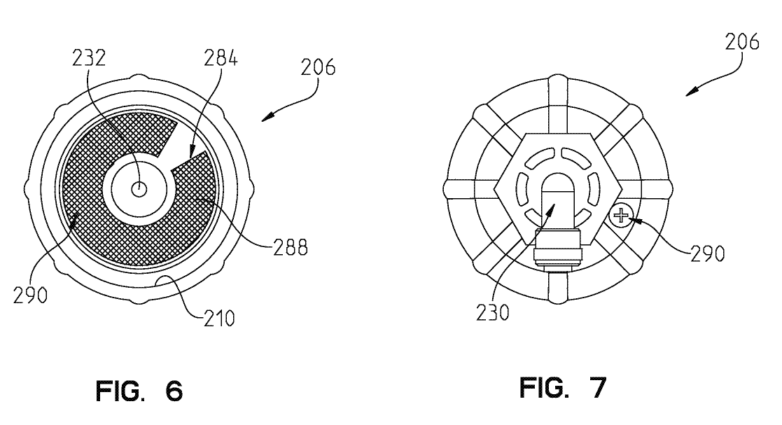

Referring to FIGS. 3-8, a first exemplary membrane unit 200 is shown. Referring to FIG. 5, membrane unit 200 includes a housing 202 having a first housing portion 204 and a second housing portion 206. Illustratively, first housing portion 204 is an elongated member having an interior 208. In the illustrated embodiment, first portion interior 208 is generally cylindrical. Illustratively, second housing portion 206 is a cap having an inner threaded portion 210 (see FIG. 6) which is engaged with an external threaded portion 212 of first housing portion 204.

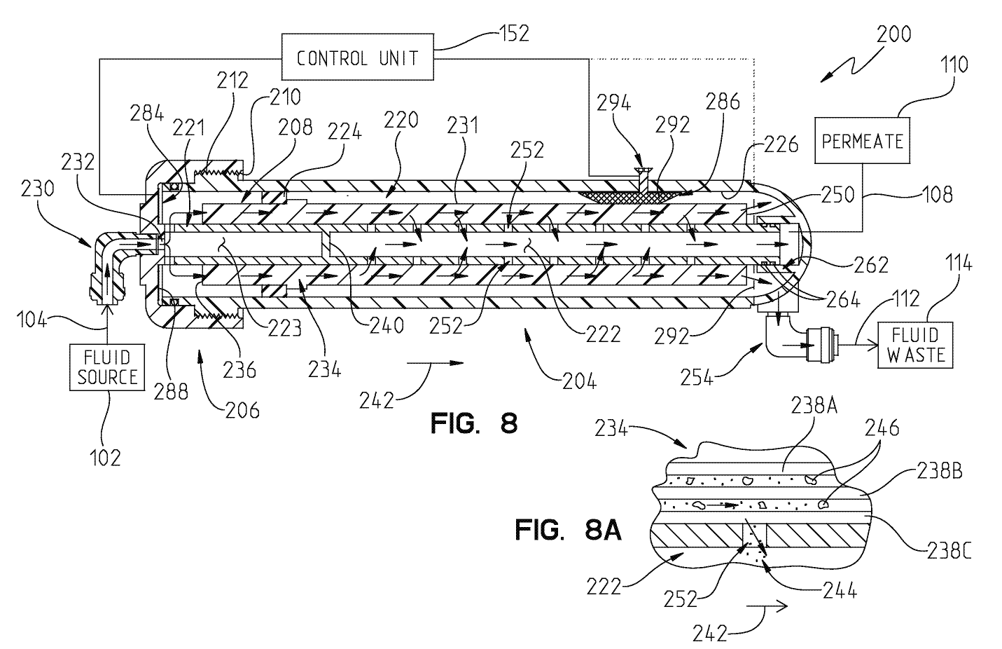

A membrane cartridge 220 of first exemplary membrane unit 200 is received in first portion interior 208 of first housing portion 204. Referring to FIG. 8, membrane cartridge 220 includes a fluid conduit 222 (see FIG. 8) formed by a tube 221. Membrane cartridge 220 further includes a seal 224 which seals off against wall 226 of first housing portion 204.

Fluid conduit 104 is coupled to a fitting 230 coupled to second housing portion 206 and flows through an opening 232 in second housing portion 206. The fluid either enters a recess 223 in tube 221 or flows around tube 221. The fluid entering recess 223 is prevented from further advancement due to a wall 240 of tube 221. Fluid flowing around tube 221 enters a membrane 234 through an end face 236 of membrane 234. Membrane 234 is retained in wall 231.

As the fluid travels along membrane 234 in direction 242 between layers 238 (see FIG. 8A) of membrane 234, particles and fluid which are small enough to pass through the layers 238 of membrane 234 migrate towards fluid conduit 222 of membrane cartridge 220. Referring to FIG. 8A, three layers 238A-C of membrane 234 are represented. In one embodiment, layers 238A-C are formed from a membrane sheet wrapped around tube 221. Small particles 242 in the fluid and generally pure fluid may pass through the layers 238 of membrane 234 and into fluid conduit 222 through openings 252 while larger particles 244 cannot pass through the membrane layers 238 and generally continue in direction 242 until they exit membrane 234 at end face 250.

The fluid and larger particles exiting end face 250 of membrane 234 are communicated to fluid conduit 112 through a fitting 254. The fluid and smaller particles 244 exiting fluid conduit 222 are communicated to fluid conduit 108 through a fitting 256. An end 260 of tube 221 is received in a fluid conduit 262 of first housing portion 204. Fluid conduit 262 is in fluid communication with fitting 256. Two seals 264 seal the connection between fluid conduit 222 and fluid conduit 262 and prevent fluid waste 114 from entering the permeate stream 110.

Exemplary membranes 234 include reverse osmosis membranes, nano-filtration membranes, and ultra-filtration membranes. In one embodiment, reverse osmosis membranes filter out contaminants greater in size than about 0.0001 microns for some membranes to greater in size than about 0.001 microns for other membranes. In one embodiment, nano-filtration membranes filter out contaminants greater in size than about 0.0008 microns for some membranes to greater in size than about 0.01 microns for other membranes. In one embodiment, ultra-filtration membranes filter out contaminants greater in size than about 0.001 microns for some membranes to greater in size than about 0.1 microns for other membranes. Exemplary membranes include FILMTEC brand membranes available from Dow Chemical Company located in Midland Mich. Further details regarding exemplary membranes, exemplary applications, and exemplary packaging are provided in Appendix A titled “FILMTEC Membranes: Product Information” from Dow Liquid Separations of U.S. Provisional Patent Application Ser. No. 60/955,244, filed Aug. 10, 2007, the disclosure of which is expressly incorporated by reference. One exemplary membrane cartridge 220 is Model No. W-1812-50 available from Watts Membranes located in Dunnellon, Fla. 34430.

Problems arise with membrane 234 when larger particles 246 become lodged in the layers 238A-C of membrane 234. This results in membrane 234 becoming clogged and reduces the amount of fluid which is communicated to fluid conduit 222.

The fluid entering membrane 234 is treated with an electrical treatment device 280. Electrical treatment device 280 includes control unit 152 coupled to a first electrode 284 and a second electrode 286. An electrical circuit is formed by control unit 152, first electrode 284, second electrode 286, and the fluid within membrane unit 200. Referring to FIG. 6, first electrode 284 includes a screen 288 coupled to a screw 290. Screw 290 is in contact with screen 288 on an inside of second housing portion 206 and is visible from an exterior of second housing portion 206. Screw 290 is coupled to control unit 152 through a wire. Referring to FIG. 5, second electrode 286 includes a screen 292 coupled to a screw 294. Screw 294 is in contact with screen 292 on an inside of first housing portion 204 and is visible from an exterior of first housing portion 204. Screw 294 is coupled to control unit 152 through a wire. Referring to FIG. 8, an alternative location for screen 292 is shown positioned adjacent end face 250 of membrane 234.

As mentioned herein, control unit 152 provides a potential difference between a first electrode, (electrode 284 for membrane unit 200) and a second electrode (electrode 286 for membrane unit 200). As mentioned herein, in one embodiment, the potential difference is an alternating potential difference. In one embodiment, one of the first electrode and the second electrode is at a ground potential and the other of the first electrode and the second electrode is at a potential controlled by control unit 152, herein referred to as the hot electrode.

In one embodiment, the control unit 152 provides a generally sinusoidal varying potential to the hot electrode. In one embodiment, the characteristics of the potential provided to the hot electrode are set by the control unit 152 based on a sensed current flowing in the fluid between the electrodes. As such, in this embodiment the potential provided by the control box is controlled by the current flowing in the fluid. The level of current flowing in the fluid changes based on the characteristics of the fluid. In one embodiment, a target current in the fluid is about 250 milli-amperes (“mA”) with a voltage of up to about 100 Volts Alternating Current (“VAC”). In one embodiment, the target current is in the range of about 10 mA to about 0.5 amperes (“A”). In one embodiment, the frequency of the sinusoidal output of control unit 152 is in the range of about 100 Hertz (“Hz”) to about 50 mega-hertz (“MHz”). In one embodiment, the frequency of the sinusoidal output of control unit 152 is in the range of about 1 kilo-hertz (“kHz”) to about 20 kHz. In one embodiment, the frequency of the sinusoidal output of control unit 152 is in the range of about 1 kHz to about 10 kHz. In one embodiment, the frequency of the sinusoidal output of control unit 152 is in the range of about 100 Hz to about 20 kHz. In one embodiment, the frequency of the sinusoidal output of control unit 152 is in the range of about 10 kHz to about 50 MHz.

In one embodiment, electrode 284 is the hot electrode and electrode 286 (in the alternative arrangement at the end of end face 250) is grounded. The resistance of membrane unit 200 is based on the characteristics of the fluid and on the path length between electrode 284 and 286 and the cross-sectional area of the fluid stream passing through the membrane 234. This is typically a high resistance requiring the use of a high voltage to produce the targeted current. This results in the fluid in fluid conduit 104 leading to the hot electrode 284 to also be at a high potential. In order to prevent the high potential in the fluid seeking another path to ground, other than electrode 286 an isolation path should be included in fluid conduit 104.

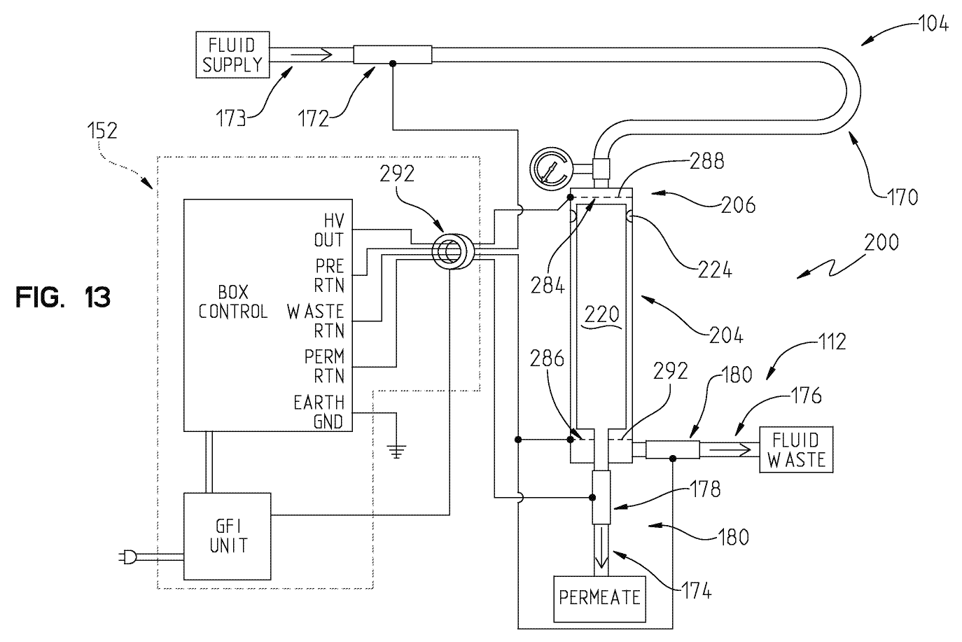

Referring to FIG. 13, fluid conduit 104 includes a non conductive portion 170 (coupled to membrane unit 200) which has a length to ensure that the fluid in fluid conduit 104 does not seek a path to ground other than electrode 286. In other words, the non-conductive portion should have a higher resistance than the resistance between first element 284 and second element 286. In one embodiment, portion 170 is about twenty feet in length and has a internal diameter of about one inch. Portion 170 is further coupled to a conductive portion 172 of fluid conduit 104. at the electrical high level the resistance of membrane unit 200. Each of fluid conduits 108 and 112 also include a non-conductive portion 174 and 176, respectively, and a conductive portion 178 and 180, respectively.

In one embodiment, electrode 286 is the hot electrode and electrode 284 is at ground. In this arrangement, both fluid conduit 108 and fluid conduit 112 would include an isolating non-conductive portion (like portion 170 of fluid conduit 104) between conductive portions 178 and 180, respectively, and membrane unit 200. As the fluid in fluid conduit 104 has a lower conductance than the fluid in fluid conduit 112 a shorter isolation section 107 may be used on the fluid conduit 104. That said, the flow rate of fluid in fluid conduit 112 should be lower than in fluid conduit 104 and the diameter of fluid conduit 112 may be less than the diameter of fluid conduit 104, both of which raises the resistance of fluid conduit 112. The fluid in fluid conduit 108 has a very low conductance and is easier to isolate with an isolating section 107.

Control unit 152 further includes a ground fault interrupt (“GFI”) unit 290 to monitor the current levels in fluid conduits 104, 108, and 112 outside of membrane unit 200. The GFI unit 290 is electrically coupled to section 172 of fluid conduit 104, section 178 of fluid conduit 108, section 180 of fluid conduit 112, and hot electrode 284 through a sensor transformer 292. Fluid conduit 104 does include a second non-conductive isolation section 173 which isolates section 172 for GFI testing. GFI unit 290 compares the currents measured at electrode 286, section 172, section 178, section 180, and hot electrode 284. If there is no current lost to other paths than between electrode 284 and electrode 286, the sum of these currents should be below a threshold current. In one embodiment, the threshold current is about 15 mA. If there is a current to ground outside of setup in FIG. 13, the sum of the currents through transformer 292 should be above the threshold current. At detecting a current above the threshold current, GFI unit 290 cuts the power to membrane unit 200.

In order to distinguish between the capacitance of the electrical wiring and the capacitance measured by GFI unit 290 from the current differences, the GFI unit 290 looks only at in-phase measurements (in phase with the sinusoidal output to hot electrode 284), not out of phase measurements.

Additional details regarding an exemplary embodiment of control unit 152 are provided in U.S. Provisional Patent Application Ser. No. 61/087,870, titled CONTROL DEVICE, filed Aug. 11, 2008, docket FRE-P0004-01, the disclosure of which is expressly incorporated by reference herein.

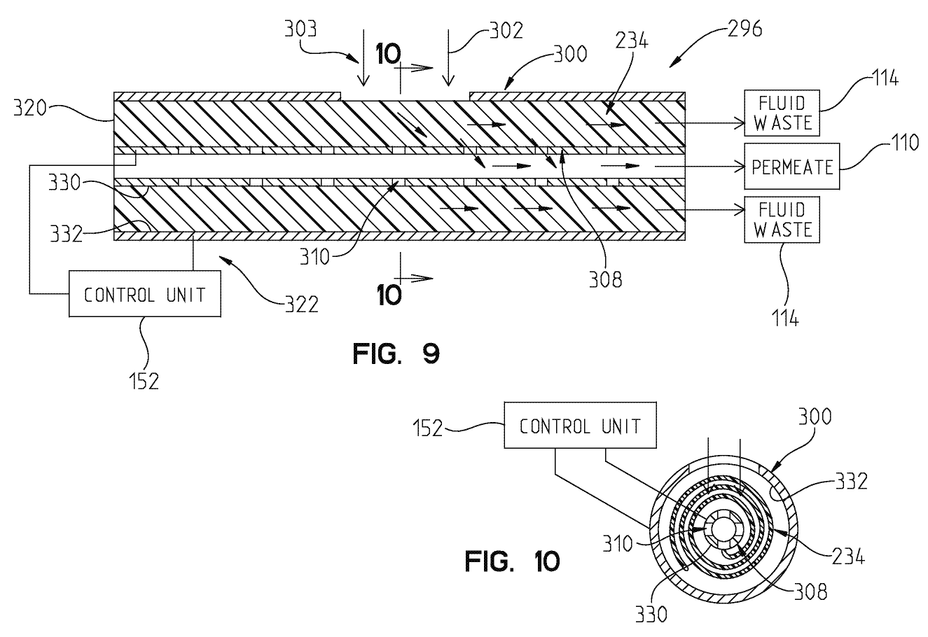

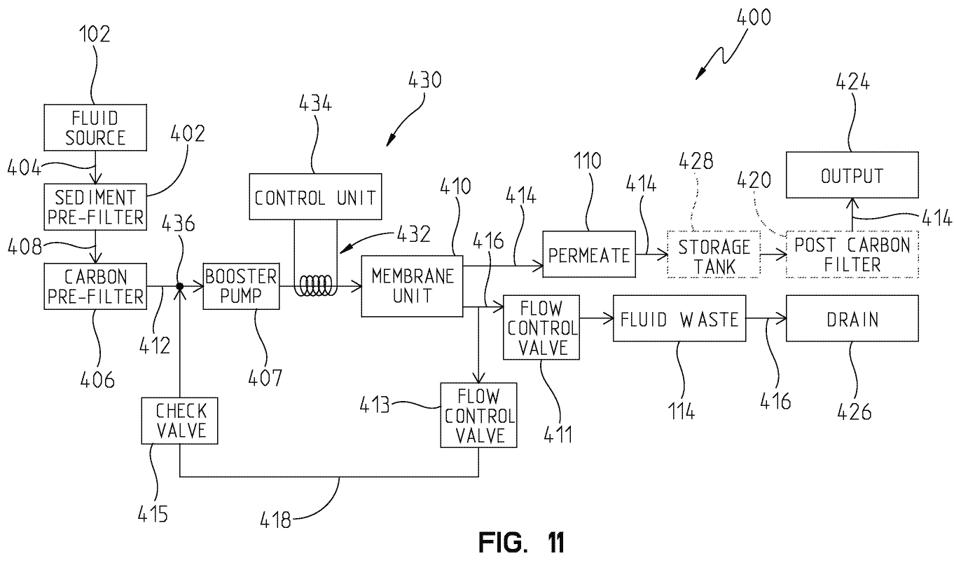

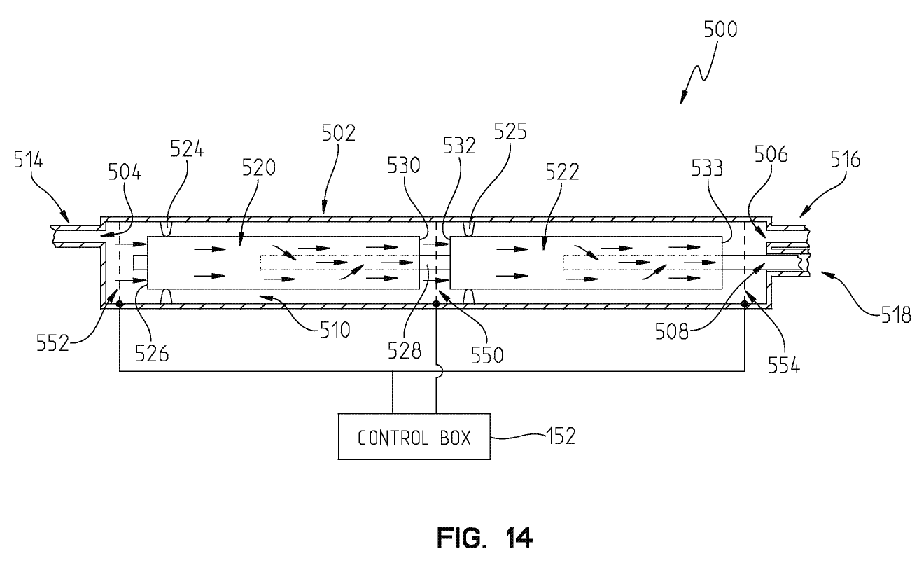

Other methods may be employed to isolate the fluid in any of fluid conduits 104, 108, and 112 from membrane unit 200. One such method is to break the physical path of the fluid itself. In one example the fluid may be sprayed through a spray head resulting in the droplets not forming a continuous path. In another example, the fluid may be encounter a chopper device, such as a rotating disc which breaks up the continuity of the fluid. Further, the arrangement of the electrodes may be altered to reduce the need for lengthy isolation sections. One such arrangement is shown in FIG. 9 and another arrangement is shown in FIG. 14.

Referring to FIG. 9, a membrane cartridge 296 is shown. Membrane cartridge 296 includes a membrane 234 having layers 238. The operation of membrane 234 is described herein. A fluid 302 is input into a fluid conduit 300 as a feed stream 303. The illustrated conduit 300 is a cylindrical tube which surrounds a circumference of membrane 234. Fluid 302 encounters membrane 234. A portion of fluid 302 passes through membrane 234 and into an interior 306 of a conduit 308. The fluid 302 enters conduit 308 through a plurality of openings 310. Membrane 234 removes unwanted materials from the portion of fluid 302 that enters conduit 308. The portion of fluid in conduit 308 is considered a permeate stream 110 which may be used for various applications.

Another portion of fluid 302 passes out of conduit 300 outside of conduit 308. This portion of fluid 302 is considered a waste stream 314. Waste stream 314 carries away the unwanted material left behind outside of conduit 308.

FIG. 10 shows a representative portion of the arrangement of conduit 300, membrane 234, and conduit 308. In one embodiment, conduit 308 and membrane 234 are components of a cartridge filter unit which is received within conduit 300. In one embodiment, conduit 308, membrane 234, and conduit 200 are components of a cartridge filter.

In one embodiment, membrane 234 is a reverse osmosis membrane. In one embodiment, membrane 234 is a nanofiltration membrane. In one embodiment, membrane 234 is an ultra-filtration membrane. In one application, wherein membrane 234 is a reverse osmosis membrane, feed stream 303 includes unwanted dissolved salts, such as sea water, or minerals. The water of feed stream 303 readily passes through membrane 234 while the dissolved salts or minerals pass through membrane 234 more slowly or not at all. As is known, in order to promote the migration of the water of feed stream 303 to the interior of conduit 308, feed stream 303 is under pressure. In one embodiment, the pressure of feed stream 303 is at least about 40 pounds-per-square-inch (PSI). In one embodiment, the pressure of the feed stream is at least about 60 PSI.

Feed stream 303 is shown entering through a radial opening 304 in fluid conduit 300. In one embodiment, feed stream 303 enters a first end face 320 of membrane 234.

Membrane cartridge 296 includes an electrical treatment device 322. Electrical treatment device 322 includes a first electrode and a second electrode coupled to control unit 152. Unlike the illustrated embodiment of membrane cartridge 220, in the illustrated embodiment of membrane cartridge 296 at least one of the first electrode and the second electrode are positioned within membrane cartridge 296.

Conduit 308 either is a first electrode or supports a first electrode. In one embodiment, conduit 308 is made of a conductive material and is a first electrode. Exemplary conductive materials include stainless steel. In one embodiment, a surface of conduit 308, such as outer surface 330, is coated with a conductive coating which is a first electrode. In one embodiment, a first electrode is coupled to or otherwise supported by conduit 308.

Conduit 300 either is a second electrode or supports a second electrode. In one embodiment, conduit 300 is made of a conductive material and is a second electrode. Exemplary conductive materials include stainless steel. In one embodiment, a surface of conduit 300, such as inner surface 332, is coated with a conductive coating which is a second electrode. In one embodiment, a second electrode is coupled to or otherwise supported by conduit 300.

As illustrated in FIG. 9, conduits 308 and 300 are each made of a conductive material and thus serve as a first electrode and a second electrode, respectively. Conduits 308 and 300 are coupled to a control unit 152. Control unit 152 provides a potential difference between conduit 308 and conduit 300. Conduits 308 and 300 are in direct contact with fluid 302.

The operation of control unit 152 is discussed herein. The current flow between the first electrode and the second electrode is in a direction generally normal to the flow of the fluid through membrane 234. This reduces the current flow along the direction of the fluid flow.

In one embodiment, the first electrode and the second electrode are incorporated as part of a filter cartridge. The filter cartridge having electrical leads to connect to the first electrode and the second electrode, at least one of the leads being insulated from the feed inlet or the waste fluid in the unit. In one embodiment, the first electrode and the second electrode are shorter than a length of membrane 234.

Referring to FIG. 14, a membrane unit 500 is shown. Membrane unit 500 includes a housing 502. Housing 502 includes a fluid supply inlet 504, a fluid waste outlet 506, and a permeate outlet 508. In one embodiment, housing 502 is made of an insulating material. in one embodiment, housing 502 is made of a conductive material and includes an insulating liner or coating. Housing 502 may be a multiple piece housing, similar to housing 200, to permit access to an interior 510 of housing 502. Further fluid supply inlet 504, fluid waste outlet 506, and permeate outlet 508 may have associated fittings similar to housing 200.

A fluid conduit 514 is coupled to fluid supply inlet 504. A fluid conduit 516 is coupled to fluid waste outlet 506. A fluid conduit 518 is coupled to permeate outlet 508. In one embodiment, each of fluid conduits 514, 516, and 518 are made of a conductive material or contact the fluid passing therethrough with a conductive member, such as a coating, and are grounded.

Within housing 502, are positioned at least two membrane devices 520 and 522. Each of membrane devices 520 and 522 include a membrane 234 which separates a feed stream into a permeate stream or portion and a fluid waste stream or portion. Membrane device 520 is sealed against housing 502 through a seal 524. As such, fluid entering fluid inlet 504 must travel through an end face 526 of membrane device 520 and through the membrane 234 of membrane device 520. Membrane device 520 operates like membrane cartridge 220. A permeate portion of the fluid is communicated out of membrane device 520 through a fluid conduit 528 while a fluid waste portion of the fluid exits an end face 530 of membrane device 520.

Membrane device 522 is sealed against housing 502 through a seal 525. Membrane device 522 receives the fluid waste portion from end face 530 of membrane device 520 through an end face 532 of membrane device 522. This fluid waste stream is separated by the membrane 234 of membrane device 522 into a permeate stream or portion and a fluid waste stream or portion. The permeate stream or portion is communicated to fluid conduit 518, while the fluid waste stream or portion is communicated to fluid conduit 516 after it exits end face 533 of membrane device 522. In one embodiment, the center conduit of membrane device 522 which receives the permeate from the membrane is in fluid communication with the center conduit of membrane device 520 such that the permeate from membrane device 520 is able to flow directly into the center conduit of membrane device 522 and onto fluid conduit 518. In one embodiment, the center conduit of membrane device 520 is communicated to a bypass fluid conduit which is not in fluid communication with the fluid traveling through membrane unit 522. The bypass fluid conduit is in fluid communication with fluid outlet 518 so that the permeate from both membrane device 520 and membrane device 522 is collected by fluid outlet 518. In one embodiment, housing 502 includes two permeate fluid outlets, one for membrane device 520 and one for membrane device 522.

Membrane unit 500 includes a center electrode 550 which is positioned between membrane device 520 and membrane device 522. The center electrode may be positioned at any point in housing 502 or be a part of housing 502 as long as it is able to contact the fluid waste stream exiting membrane device 520 (also serving as the feed stream for membrane device 522). Membrane unit 500 further includes two electrode members 552 and 554 which are tied together to act as a second electrode. Electrode member 552 is able to contact the feed fluid for membrane device 520. Electrode member 554 is able to contact the fluid waste stream of membrane device 522. As such, center electrode 550 is positioned between the first electrode member 552 and the second electrode member 554 along the fluid path of the fluid through membrane unit 500.

Center electrode 530 is coupled to control box 152 and serves as the hot electrode. Electrode members 552 and 554 are coupled to control box 152 and serve as the ground electrode.

Referring to FIG. 11, a fluid treatment system 400 is shown. Fluid treatment system 400 includes a pre-sediment filter unit 402 which receives fluid from fluid source 102 through a fluid conduit 404 and a carbon pre-filter unit 406 which receives fluid from pre-sediment filter unit 402 through a fluid conduit 408. Pre-sediment filter unit 402 removes dirt and small particles that are in the fluid. Carbon pre-filter unit 406 removes organic contaminants including chlorine. Fluid exiting carbon pre-filter unit 406 is provided to a membrane unit 410 through a fluid conduit 412 after it passes through a booster pump 407. Booster pump 407 increases the pressure of the fluid prior to its entering membrane unit 410.

In membrane unit 410 the fluid is separated into a permeate stream 110 which exits membrane unit 410 through a fluid conduit 414 and a fluid waste stream 114 which exits membrane unit 410 through a fluid conduit 416. The separation occurs through a membrane. In one embodiment, the membrane is a membrane cartridge. An exemplary membrane cartridge is Model No. W-1812-50 available from Watts Membranes located in Dunnellon, Fla. 34430. The permeate stream 110 is provided to an output 424. Exemplary outputs include application devices such as faucets, ice makers, refrigerators, and other devices to utilize the permeate. In one embodiment, a storage tank 428 receives the permeate stream 110 and stores it until needed by output 424. In one embodiment, a post-carbon filter unit 420 is provided between storage tank 428 and output 424. The post-carbon filter unit 420 improves the taste of the fluid provided to output 424, in the case wherein the fluid is drinking water.

The fluid waste stream 114 is provided to a drain 426 or other disposal. A portion of fluid waste stream 114 is recycled back to fluid conduit 412 through a fluid conduit 418. The percentage of the fluid waste that is communicated to drain 426 and recycled through fluid conduit 418 is controlled through flow control valves 411 and 413, respectively. Further a check valve 415 is provided along conduit 418 to prevent the backflow of fluid in conduit 418. In one embodiment, about 85 percent of the fluid waste stream 114 is recycled back through fluid conduit 418 to pass through membrane unit 410 again. In one embodiment, at least about 85 percent of the fluid waste stream 114 is recycled back through fluid conduit 418 to pass through membrane unit 410 again. In one embodiment, a portion of fluid waste stream 114 of up to about 85 percent is recycled back through fluid conduit 418 to pass through membrane unit 410 again.

Referring to FIG. 11, a portion of fluid conduit 412 is operatively coupled to an electrical treatment device 430. Electrical treatment device 430 includes a wire 432 which is wrapped around an exterior of fluid conduit 412 and a control unit 434. An exemplary electrical treatment device 430 is the EASYWATER brand water treatment system or SERIES E brand water treatment system both available from Freije Treatment Systems located at 4202 N. Awning Court, Greenfield, Ind. 46140. The EASYWATER brand water treatment system and SERIES E brand water treatment system both includes a wire wrapped around an exterior of the fluid conduit and a control unit. The control unit passes a current through the wire which treats the fluid for mineral scale. In one embodiment, the electrical treatment device applies an alternating current in the frequency range of about lkilo-hertz (kHz) to about 9 kHz.

Electrical treatment device 430 treats the fluid passing through fluid conduit 412. Electrical treatment device 430 interfaces with fluid conduit 412 at a location 436 subsequent to fluid conduit 118 coupling to fluid conduit 412.

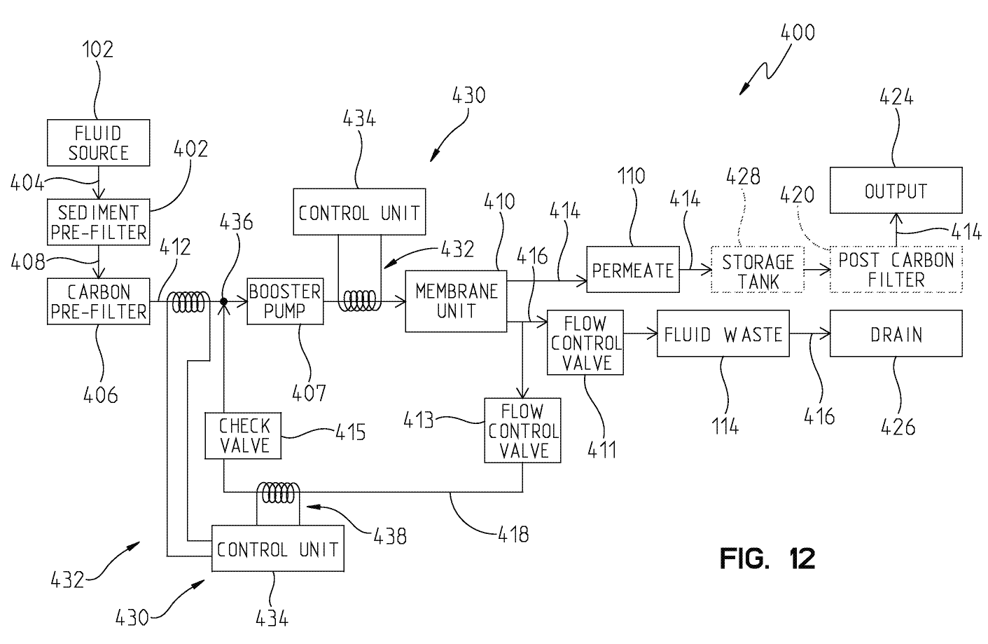

Referring to FIG. 12, a portion of fluid conduit 412 prior to the location 436 is wrapped with a first wire 432 and a portion of fluid conduit 118 is wrapped with a second wire 438. Both the first wire 432 and the second wire 438 may be coupled to the same control unit or to individual control units.

Although the invention has been described in detail with reference to certain preferred embodiments, variations and modifications exist within the spirit and scope of the invention as described and defined in the following claims.

1. A method of treating a heat transfer fluid, the method comprising the steps of:
collecting a heat transfer fluid in a sump of a cooling tower;
pumping the heat transfer fluid to an application heat exchanger whereat the heat transfer fluid takes on heat;
returning the heat transfer fluid to the cooling tower;
collecting only a portion of the heat transfer fluid in the sump of the cooling tower;
adding make-up heat transfer fluid to the cooling tower from a make-up fluid source;
treating the make-up heat transfer fluid with an electrical treatment prior to the step of adding the make-up heat transfer fluid to the cooling tower; and
passing the make-up heat transfer fluid through a membrane system prior to the step of adding the make-up heat transfer fluid to the cooling tower.

2. The method of claim 1, wherein the step of treating the make-up heat transfer fluid with an electrical treatment device includes the steps of:
providing a first electrode and a second electrode in direct contact with the make-up heat transfer fluid within a housing of the membrane system; and
applying an alternating potential difference to the first electrode and the second electrode.

3. The method of claim 2, wherein the step of treating the make-up heat transfer fluid with an electrical treatment device includes the steps of:
passing the make-up heat transfer fluid through openings in the first electrode; and
passing the make-up heat transfer fluid through openings in the second electrode.

4. The method of claim 1, wherein the step of passing the make-up heat transfer fluid through a membrane system includes the step of passing the make-up heat transfer fluid through a plurality of membrane devices connected together in series.

5. The method of claim 4, wherein the step of treating the make-up heat transfer fluid with an electrical treatment device includes the steps of:
providing a first electrode and a second electrode in direct contact with the make-up heat transfer fluid within a housing of the membrane system, at least one of the first electrode and the second electrode being positioned between the plurality of membrane devices; and
applying an alternating potential difference to the first electrode and the second electrode.

6. The method of claim 4, wherein the step of treating the make-up heat transfer fluid with an electrical treatment device includes the steps of:
wrapping a wire around a fluid conduit which is in fluid communication with the input to the membrane system;
applying an alternating current in the frequency range of about 1 kHZ to about 9 kHZ to the wire.

7. A fluid treatment device for treating a water based fluid, the fluid treatment device comprising:
a housing having at least one fluid inlet and at least two fluid outlets;
a membrane positioned within the housing, the membrane receiving the water based fluid from the at least one fluid inlet through a first end surface of the membrane, the membrane separating the water based fluid into a permeate portion and a fluid waste portion, the permeate portion being communicated to at least a first fluid outlet of the at least two fluid outlets and the fluid waste portion exiting a second end surface of the membrane opposite from the first end surface of the membrane and being communicated to at least a second fluid outlet of the at least two fluid outlets;
a first electrode positioned within the housing;
a second electrode positioned within the housing; and
a control unit coupled to the first electrode and the second electrode, the control unit providing an alternating potential difference between the first electrode and the second electrode.

8. The fluid treatment device of claim 7, wherein the first electrode and the second electrode are each in direct contact with the water based fluid.

9. The fluid treatment device of claim 8, wherein the first electrode and the second electrode are each coupled to the housing.

10. The fluid treatment device of claim 8, wherein at least one of the first electrode and the second electrode includes openings which permit the water based fluid to pass therethrough.

11. The fluid treatment device of claim 7, wherein at least one of the first electrode and the second electrode are a part of a fluid conduit for the permeate portion of the water based fluid.

12. The fluid treatment device of claim 7, wherein at least one of the first electrode and the second electrode are a part of a fluid conduit for the fluid waste portion of the water based fluid.

13. The fluid treatment device of claim 7, further comprising
a fluid waste fluid conduit; and
a permeate fluid conduit positioned within the fluid waste fluid conduit, wherein the membrane is positioned within the fluid waste fluid conduit and outside of the permeate fluid conduit and the permeate fluid conduit includes openings to permit permeate within the fluid waste fluid conduit to enter the permeate fluid conduit and the first electrode is a part of the permeate fluid conduit and the second electrode is a part of the fluid waste fluid conduit.

14. The fluid treatment device of claim 7, wherein the first electrode is positioned adjacent a first end of the membrane and the second electrode is positioned adjacent a second end of the membrane.

15. The fluid treatment device of claim 14, wherein the first electrode is generally parallel to the second electrode.

16. A method for treating a fluid, comprising the steps of:
providing a feed stream of a fluid to a membrane, the feed stream being pressure driven and entering the membrane through a first end face;
collecting a first portion of the feed stream which passes through the membrane as a permeate stream;
collecting a second portion of the feed stream from a second end face of the membrane as a fluid waste stream; and
treating the fluid by placing a first electrode and a second electrode in contact with the fluid and applying an alternating potential difference to the first electrode and the second electrode.

17. The method of claim 16, further comprising the step of passing the fluid of the feed stream through a sediment filter prior to the fluid being provided to the membrane.

18. The method of claim 16, further comprising the step of passing the fluid of the feed stream through a carbon filter prior to the fluid being provided to the membrane.

19. The method of claim 16, further comprising the step of passing the permeate stream through a carbon filter.

20. The method of claim 16, wherein the membrane is a reverse osmosis membrane and at least one of the first electrode and the second electrode contacts the feed stream inside of the reverse osmosis membrane.

21. The method of claim 16, wherein the membrane is a reverse osmosis membrane and at least one of the first electrode and the second electrode contacts the feed stream outside of the reverse osmosis membrane.

22. A fluid treatment system for treating a water based fluid, the fluid treatment system comprising:
a membrane unit including at least one fluid inlet, at least two fluid outlets, and a membrane, the membrane receives the water based fluid from the at least one fluid inlet and separates the water based fluid into a permeate portion and a fluid waste portion;
a first fluid conduit in fluid communication with the at least one fluid inlet of the membrane unit, the first fluid conduit providing the water based fluid to the membrane unit;
a second fluid conduit in fluid communication with a first fluid outlet, the second fluid conduit receiving the permeate portion;
a third fluid conduit in fluid communication with a second fluid outlet, the third fluid conduit receiving the fluid waste portion;
a fourth fluid conduit in fluid communication with the first fluid conduit at a first location and with the third fluid conduit, the fourth fluid conduit providing at least a portion of the fluid waste portion to the first fluid conduit at the first location; and
an electrical treatment device including at least one wire and a control unit coupled to the at least one wire and providing an alternating potential over the at least one wire, the at least one wire being wrapped around a portion of the first fluid conduit to treat the water based fluid prior to entering the membrane unit, the portion of the first fluid conduit being between the first location and the membrane unit.

23. The fluid treatment system of claim 22, further comprising a sediment filter which provides the water based fluid to the first fluid conduit.

24. The fluid treatment system of claim 22, further comprising a carbon filter which provides the water based fluid to the first fluid conduit.

25. The fluid treatment system of claim 22, further comprising a carbon filter which receives the permeate portion from the second fluid conduit.

26. A fluid treatment system for treating a water based fluid, the fluid treatment system comprising:
a membrane unit including at least one fluid inlet, at least two fluid outlets, and a membrane, the membrane receives the water based fluid from the at least one fluid inlet and separates the water based fluid into a permeate portion and a fluid waste portion;
a first fluid conduit in fluid communication with the at least one fluid inlet of the membrane unit, the first fluid conduit providing the water based fluid to the membrane unit;
a second fluid conduit in fluid communication with a first fluid outlet, the second fluid conduit receiving the permeate portion;
a third fluid conduit in fluid communication with a second fluid outlet, the third fluid conduit receiving the fluid waste portion;
a fourth fluid conduit in fluid communication with the first fluid conduit at a first location and with the third fluid conduit, the fourth fluid conduit providing at least a portion of the fluid waste portion to the first fluid conduit at the first location; and
an electrical treatment device including at least two wires and at least one control unit coupled to the at least two wires, the at least one control unit providing an alternating potential over a first wire of the at least two wires and over a second wire of the at least two wires, the first wire being wrapped around a portion of the first fluid conduit to treat the water based fluid prior to entering the membrane unit, the portion of the first fluid conduit being prior to the first location, and the second wire being wrapped around a portion of fourth fluid conduit.

27. The fluid treatment system of claim 26, further comprising a sediment filter which provides the water based fluid to the first fluid conduit.

28. The fluid treatment system of claim 26, further comprising a carbon filter which provides the water based fluid to the first fluid conduit.

29. The fluid treatment system of claim 26, further comprising a carbon filter which receives the permeate portion from the second fluid conduit.

30. A fluid treatment device for treating a water based fluid, comprising:
at least two electrodes placed in direct contact with the water based fluid;
a control unit coupled to the at least two electrodes to provide an alternating potential difference between the first electrode and the second electrode; and
a reverse osmosis membrane positioned between the at least two electrodes, wherein an outer fluid conduit is the first electrode, an inner fluid conduit is the second electrode, and the reverse osmosis membrane is positioned between the outer fluid conduit and the inner fluid conduit, a portion of the water based fluid flowing from the reverse osmosis membrane into the inner fluid conduit through openings in the second electrode, the portion of the water based fluid being collected as a permeate stream of fluid.

31. The fluid treatment device of claim 30, wherein the first electrode, the reverse osmosis membrane, and the second electrode are concentrically arranged.

32. The fluid treatment device of claim 31, wherein the first electrode includes a radial opening through which the water based fluid enters the reverse osmosis membrane.

33. The fluid treatment device of claim 31, wherein the first electrode, the reverse osmosis membrane, and the second electrode form a cartridge filter unit.
